(19) United States
(12) Patent Application Publication
(10) Pub. No.: US 2009/0195814 A1
(43) Pub. Date: Aug. 6, 2009

(54) INFORMATION PROCESSING SYSTEM, INFORMATION PROCESSING METHOD, AND STORAGE MEDIUM

(75) Inventors: Hiroshi Tojo, Fuchu-shi (JP); Masahiro Matsushita, Yokohama-shi (JP); Koichi Magai, Tokyo (JP); Kotaro Yano, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/328,614

(22) Filed: Dec. 4, 2008

(30) Foreign Application Priority Data
Dec. 5, 2007 (JP) 2007-314789

(51) Int. Cl. G06F 3/12

(52) U.S. Cl. 358/1.15

(57) ABSTRACT

Embodiments of the invention relate to an information processing system that is triggered by a detection of a medium removing action, detects a user's action of leaving a sheet discharge tray from which the user has removed the medium, and counts the number of carrying-away users. The information processing system counts as the number of outputting users the number of users who have issued an instruction to output a medium. Based on the number of users who removed and left and the number of outputting users, the information processing system sends a notification prompting to check a carried-away medium or a medium that the user is about to carry away from the sheet discharge tray.

### BACKGROUND OF THE INVENTION

1. Field of the Invention

The present invention relates to an information processing system that includes a device to output a medium in response to requests from a plurality of users like a printer, a multifunction peripheral (a printer, a facsimile, a copying machine, etc. are integrated), an information processing method, and a storage medium.

2. Description of the Related Art

With conventional technologies, movement of a user or a medium output from a printer that remains in a printer body can be detected using an imaging device or a sensor.

For example, Japanese Patent Application Laid-Open No. 2001-202551 discusses a system configured to prevent a user from forgetting to remove a medium output from an outputting device. The system includes a unit for detecting movement of a user, a unit for detecting a remaining medium in the outputting device, and a warning unit. If the medium still remains in the outputting device when the user leaves from the outputting device, a warning is given to the user.

In Japanese Patent Application Laid-Open No. 11-282999, in order to detect the movement of a user with an imaging device, the number of users who passed a predetermined image pick-up area for the imaging device is counted by analyzing the images captured by the imaging device.

However, in the system discussed in Japanese Patent Application Laid-Open No. 2001-202551, when the user removes his medium, it may be difficult to warn the user not to remove a medium output by another user.

According to the method discussed in Japanese Patent Application Laid-Open No. 11-282999, all users who approach the device are counted. Accordingly, users who perform operations other than removing of the medium or just pass near the device are also counted. Accordingly, it is may be difficult to count only the number of users who have performed the specific operation (operation to remove a medium).

### SUMMARY OF THE INVENTION

In one embodiment, the present invention is directed to an information processing system that includes a device that outputs a medium in response to output instructions from one or a plurality of users. For example, in one aspect the present invention is directed to an information processing system configured to reduce a possibility or give a notice that a medium has been mistakenly removed by a user.

According to an aspect of the present invention, an information processing system includes an outputting device configured to output a medium in response to an output instruction from a user, an imaging device configured to capture an image in an area that includes the outputting device, and a detecting device configured to detect whether the medium output in response to the output instruction remains in the outputting device, and a managing device. The outputting device includes an outputting user counting unit configured to count the number of users who instructed to output the medium as the number of outputting users, and a warning unit configured to issue a warning notified from the managing device. The managing device includes a carrying-away user counting unit configured to count the number of users who removed the output medium and left the printing device as the number of users who removed and left by processing the image captured by the imaging device, and a notifying unit configured to notify the outputting device of a predetermined warning based on existence of the remaining medium detected by the detecting device, the number of users who removed and left, and the number of outputting users.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain various principles of the invention.

FIG. 1 is a block diagram illustrating an exemplary configuration of an information processing system according to an exemplary embodiment of the present invention.

FIG. 2 is a view illustrating a functional configuration of the information processing system according to an exemplary embodiment of the present invention.

FIG. 3 is a time-line chart illustrating operations performed in a notifying unit and a warning unit according to an exemplary embodiment of the present invention.

FIG. 4 is a flowchart illustrating processing performed in the information processing system according to an exemplary embodiment of the present invention.

FIG. 5 is a schematic diagram illustrating processing for detecting a medium removing action according to an exemplary embodiment of the present invention.

FIG. 6 is a schematic diagram illustrating processing for detecting a leaving action according to an exemplary embodiment of the present invention.

FIGS. 7A and 7B are schematic diagrams illustrating processing for detecting remaining medium according to an exemplary embodiment of the present invention.

FIG. 8 is a flowchart illustrating a procedure of a medium confirmation and determination according to an exemplary embodiment of the present invention.

FIG. 9 is a schematic configurational block diagram illustrating a management personal computer (PC) according to an exemplary embodiment of the present invention.

### DETAILED DESCRIPTION OF THE EMBODIMENTS

Embodiments of the invention will be described in detail below with reference to the drawings.

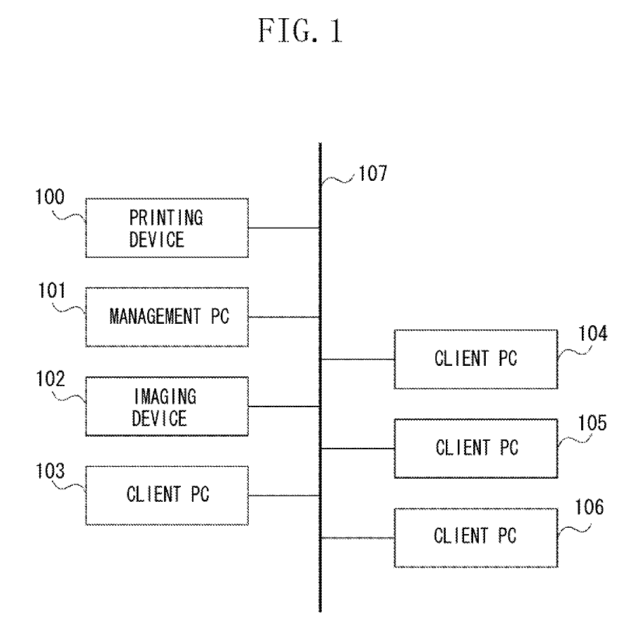

FIG. 1 is a block diagram illustrating an exemplary configuration of an information processing device according to an exemplary embodiment of the present invention.

According to this embodiment, a printing device 100 that functions as an outputting device, a management PC 101 that functions as a managing device, an imaging device 102 and client PCs 103 to 106 are connected to a local area network (LAN) 107.

A user uses an application running on the client PCs 103 to 106 to create a document and transmit a print instruction (output instruction) to the printing device 100.

The printing device 100 receives the print instruction transmitted from the client PCs 103, 104, 105, or 106 via the LAN 107, and prints an image on a recording medium according to image data contained in the print instruction.

When printing is completed, a user can come to the printing device 100 to remove the print product of the user.

The imaging device 102 may be installed above the printing device 100 to capture an image of the area including the printing device 100 and a user coming to remove a print product.

The management PC 101, based on a state of the printing device 100 and the image captured by the imaging device 102, determines whether it is necessary to check the medium, and gives a notice to or warns the user.

The management PC 101 and the client PCs 103 to 106 can include storage units that have read-only memories (ROMs) and random access memories (RAMs) for storing programs, processing units that have central processing units (CPUs) that implement the programs, and communication units, respectively.

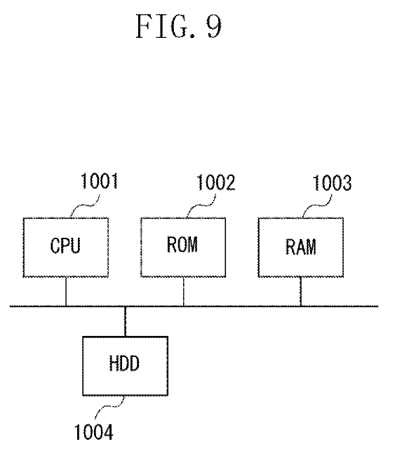

FIG. 9 is a block diagram illustrating a schematic configuration of the processing unit and the storage unit in the management PC 101 according to an exemplary embodiment of the present invention.

A ROM 1002 or a hard disk drive (HDD) 1004 stores a program (described below) corresponding to a flow according to the exemplary embodiment. The program is loaded onto a RAM 1003 in response to a request from a CPU 1001, and implemented by the CPU 1001.

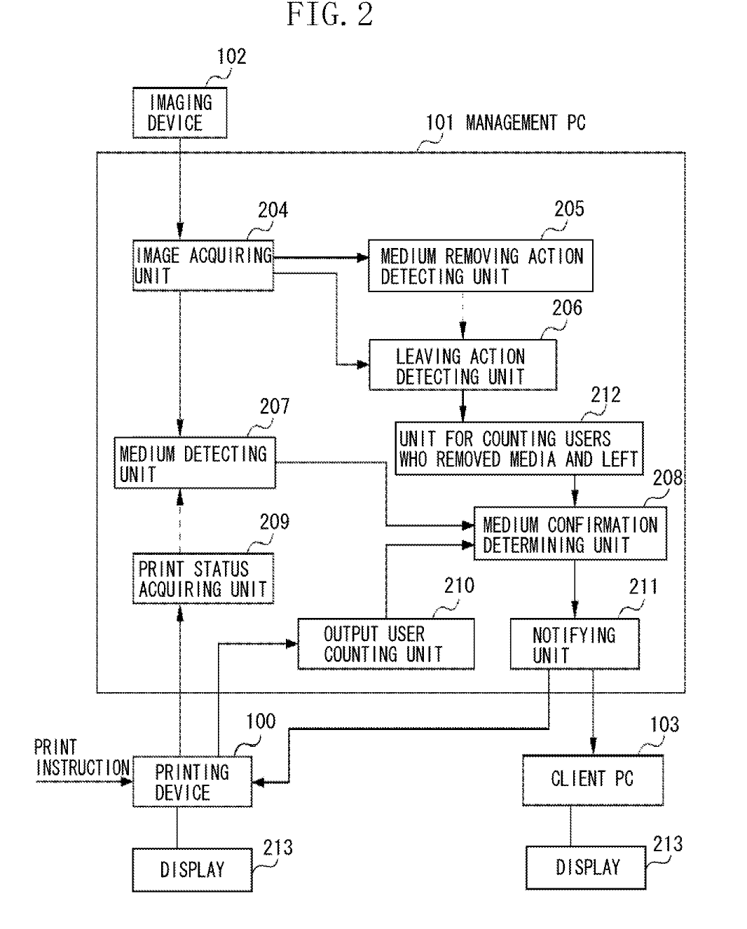

FIG. 2 is a view illustrating a functional configuration of the information processing system according to an exemplary embodiment of the present invention.

According to one embodiment of the invention, an image acquiring unit 204 acquires a frame image from the imaging device 102. In this embodiment, it may be assumed that the image acquired from the imaging device 102 is a moving image, however, the image may also be consecutive still images taken at a predetermined time interval.

A medium removing action detecting unit 205, based on the frame image, detects an action to remove a medium such as paper. A leaving action detecting unit 206, based on the frame image, detects a leaving action of the user who removes the medium.

A taking-away-user counting unit 212 counts the number of users who remove a print product from a discharge tray (hereinafter, referred to as sheet discharge tray) and leave the printing device when the medium removing action detecting unit 205 detects a removing action and the leaving action detecting unit 206 detects a leaving action.

A print status acquiring unit 209 acquires an output status (hereinafter, referred to as print status) of the printing device 100, for example, print start, printing, or print end. A medium detecting unit 207 detects based on the frame image whether a sheet (medium) remains on the sheet discharge tray. It is desirable that the processing is started by the print status acquiring unit 209.

An outputting user counting unit 210, based on an output instruction (hereinafter, referred to as print instruction) received by the printing device 100, extracts and counts information about a user who transmitted print instruction for starting printing, and information about the device. The user information and the device information are temporarily stored in a storage part such as the storage unit in the management PC or the RAM in the printing device. The user and the device that transmitted the print instruction can be identified by the user information and the device information.

A medium confirmation and determination unit 208 detects whether it is necessary to check the medium based on the information obtained by the above-described processing, that is, the number of users who removed the medium and left the printing device, the number of users outputting out the medium (hereinafter, referred to as the number of print users), and existence or non-existence of the medium on the sheet discharge tray.

A notifying unit 211, based on the state detected by the medium confirmation and determination unit 208, transmits a notice whether to check documents or a warning to the printing device 100 or the client PC 103 when a medium is mistakenly removed.

A display 213 displays the warning transmitted by the notifying unit 211 to prompt a user to check a print product so that the possibility that the print product is mistakenly removed is reduced. The display 213 can be a liquid crystal display provided in the printing device 100 or the client 103.

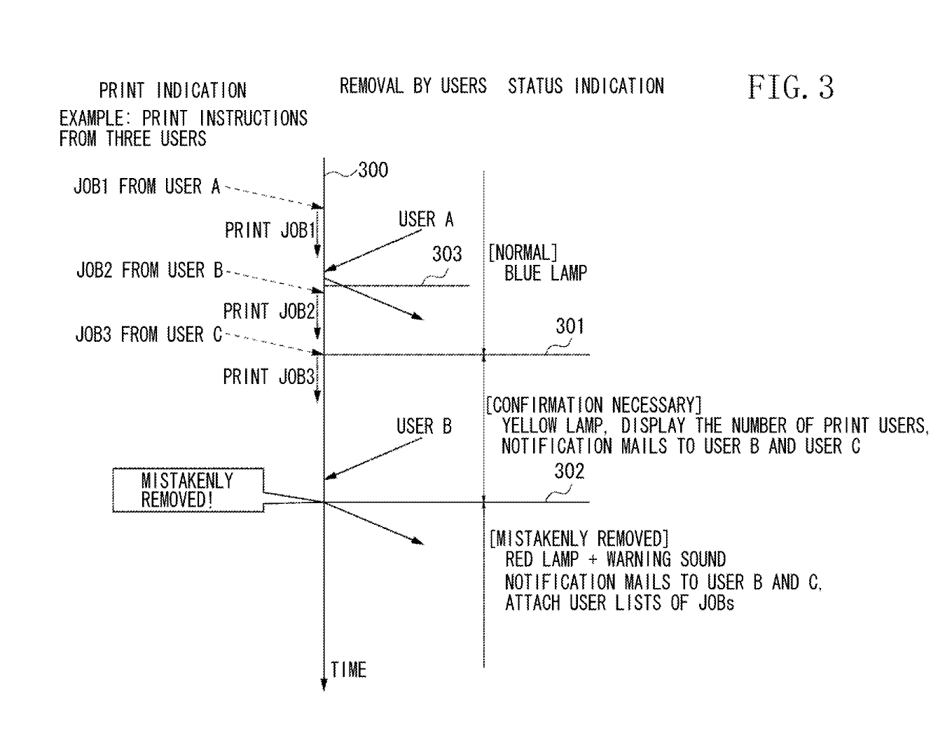

An operation overview according to the first exemplary embodiment is described with reference to FIG. 3. FIG. 3 is a chart illustrating an operation performed in the notifying unit and the warning unit in a case where each of three users A, B, and C respectively prints one copy of a document using the printing device 100. In the drawing, an arrow 300 shows the passage of time. On a left side of the arrow 300, print instructions received by the printing device 100 and printing statuses of the printing device 100 are shown. On a right side of the arrow 300, operations of removing a print product by the users and operations of notifying the warning according to the first exemplary embodiment are shown.

When the user A issues a print instruction using the client PC 103, a print instruction (JOB1) is transmitted from the client PC 103 to the printing device 100, and a printing operation is started. When the printing operation is ended, only a print product of the user A exists on the sheet discharge tray of the printing device 100. Then, when the user A removes the print product, there is no print product left on the sheet discharge tray. When a print instruction (JOB2) is transmitted to the printing device 100 by the user B and the printing is ended, only a print product of the user B exists on the sheet discharge tray. In such a state 301, if a print instruction (JOB3) is transmitted to the printing device 100 by the user C before the user B comes to remove the print product and the printing is started, not only the print product of the user B, but also the print product of the user C exists on the sheet discharge tray.

Until a state 303, only the print product of the user A who comes to remove the print product exists on the sheet discharge tray. Therefore, there is no problem if the user A removes the print product without checking the print product. Accordingly, the user A is notified that it is not necessary to check the print product. For example, a lamp that indicates whether a medium is to be checked, according to a warning from the notifying unit 211 can be provided as a displaying unit to the printing device 100. The user A can see the lamp when he comes near the printing device 100 to remove the print product and determine whether to check the print product in advance.

Now, processing performed in a case where the user B has mistakenly removed the print product belonging to the user B and the user C from the sheet discharge tray and left the printing device in a state 302 is described. In this case, the print instruction shows that the number of print users is two, that is, the user B and the user C. However, the number of users who come to remove the print products (after the time 303 when the sheet discharge tray became empty) is one.

Accordingly, if the number of print users does not correspond to the number of users who removed the print products and left (hereinafter, referred to as the number of users who removed and left), the printing device 100 determines that the print products have been mistakenly removed. Then, a warning is issued to the user B who could have mistakenly removed the print products. For example, a warning sound can be made or a warning message can be sent from a speaker in the printing device 100.

Further, if the user B leaves the device without noticing the warning sound, the user C can be notified that the print product of the user C have been removed by the user B. For example, a lamp that indicates that a print product has been removed can be provided on the printing device 100.

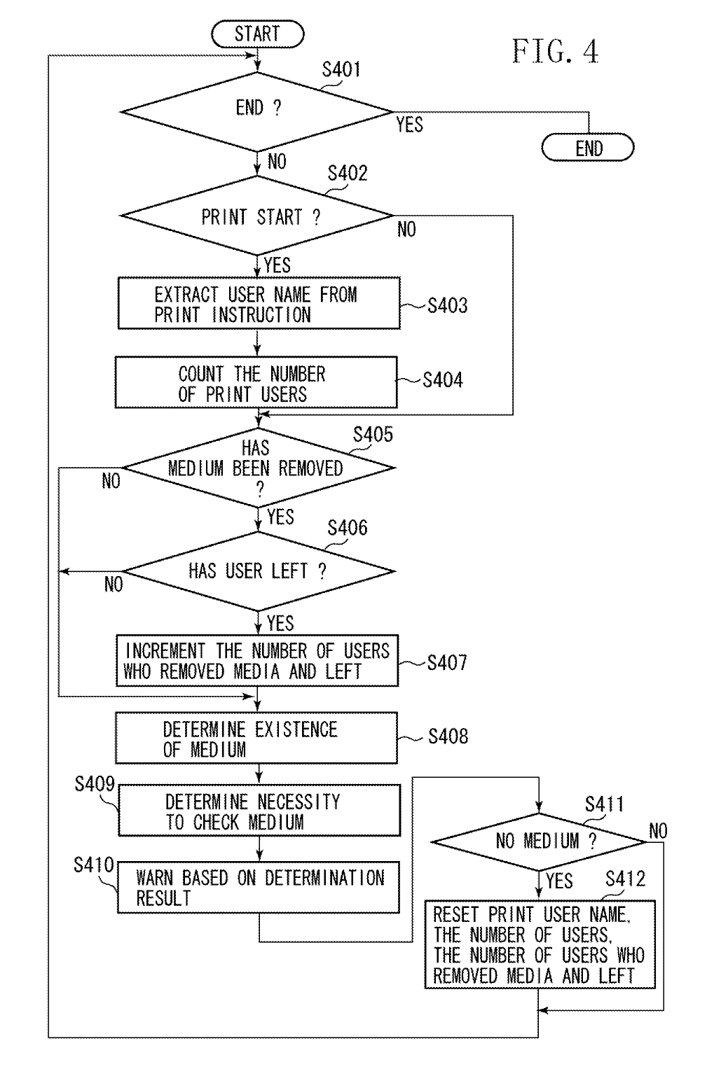

FIG. 4 is a flowchart illustrating processing performed in the information processing system according to an exemplary embodiment of the present invention. Step S401 is an end determination, and processing performed in steps S402 to S412 are repeated until an end instruction is issued by a user.

According to one embodiment, in step S402, the print status acquiring unit 209 acquires a print status of the printing device 100, and checks whether a printing operation is started. If the printing operation is started (YES in S402), the processing proceeds to step S403. In step S403, the outputting user counting unit 210 extracts a user name (user name used when the client PC 103 is operated over a network) from the print instruction. Then, the outputting user counting unit 210 temporarily stores the extracted user name in the management PC 101 or the RAM in the printing device 100.

In step S404, the outputting user counting unit 210 counts the number of print users from the temporarily stored user names. In three jobs, if two jobs are sent by a user and a remaining job is sent by another user, the number of the users is two. In step S402, if the printing operation of the printing device 100 is not started (NO in step S402), for example, a print product has not been discharged onto the sheet discharge tray, steps S403 and S404 can be skipped.

In step S405, the medium removing action detecting unit 205 detects an action taken by a user to remove a print product from the sheet discharge tray. If it is determined that the removing action has not been performed (NO in step S405), processing to be performed in steps S406 and S407 are skipped.

If it is determined in step S405 that the removing action has been performed (YES in step S405), the processing proceeds to step S406. In step S406, the leaving action detecting unit 206 starts to determine whether the user who removed the medium has left the device. The processing is described below in detail. Until it is determined that the leaving action has been performed, even if the removing actions are repeatedly detected, the user has not completed a removing action of the print product. If it is determined that the leaving action has not been performed (NO in step S406), processing to be performed in step S407 is skipped. When the user's leaving action is detected (YES in step S406), it can be first determined that the user has removed the medium and left the device. Then, the processing moves to step S407.

In step S407, the carrying-away user counting unit 212 increments the number of carrying-away users temporarily stored in the RAM. However, until a leaving action of the user is detected, step S407 is skipped.

In step S408, the medium detecting unit 207 detects whether a print product exists on the sheet discharge tray of the printing device 100. In step S409, the medium confirmation determining unit 208 determines whether it is necessary to check the medium based on the number of print users, the number of users who removed and left, the state of the printing, and an existence of the print product on the sheet discharge tray.

In step S410, the notifying unit 211, depending on a determination result of the medium confirmation determining unit 208, the number of print users, and the number of users who removed and left, notifies the user of a predetermined warning via the printing device 100 or the display 213 in the client PC 103.

In step S411, if the medium detecting unit 207 does not detect any print product on the sheet discharge tray (YES in step S411), the processing proceeds to step S412 of a resetting operation. In step S412, the names of print users, the number of print users, and the number of users who removed and left that are temporarily stored in the RAM are initialized to zero. If a print product exists on the sheet discharge tray (NO in step S411), the processing skips step S412 and returns to step S401.

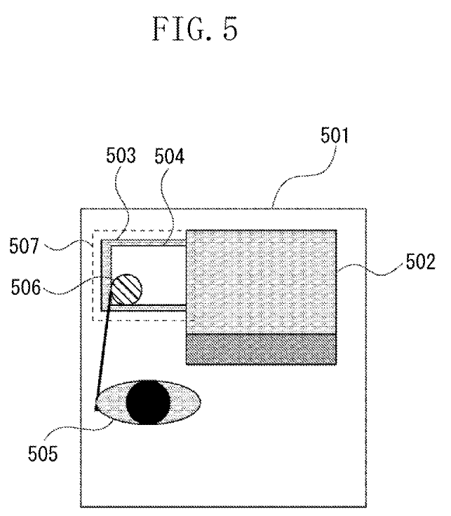

The above-described processes correspond to a processing overview according to one exemplary embodiment of the invention. Each process is further described in detail as follows. FIG. 5 is a schematic diagram illustrating an embodiment of an image captured by the imaging device 102 that is installed above the printing device 100. In the drawing, an area 501 is an imaging range of the imaging device 102, a rectangle 502 is the printing device 100, a rectangle 503 is the sheet discharge tray of the printing device 100, and an ellipse 505 is a user who is removing a print product.

As described above, the imaging device 102 captures not only an image of the printing device 100, but also an image in a range where a user removes a print product or performs an operation. In the drawing, the user 505 is about to remove a print product 504 from a sheet discharge tray 503, and is reaching out his hand 506.

A first monitoring area 507 (rectangular area shown by a dotted line) may beset so as to include the entire sheet discharge tray 503 in the area 501. It is useful that a user sets these areas as initial areas when the imaging device 102 and the printing device 100 are installed. However, these areas can also be set by capturing an image of a marker provided on a sheet discharge tray using the imaging device 102 and analyzing the image, or by identifying a color, a shape, or the like of the sheet discharge tray.

The medium removing action detecting unit 205 can determine whether the user has performed a removing action by detecting whether an area of skin color of the hand 506 appears within the first monitoring area 507 in each frame. For example, a predetermined range of skin color can be statistically obtained in advance. The determination of the skin color can be performed by determining whether pixels appearing in the first monitoring area 507 are within the predetermined range of the color. If pixels within the predetermined range exist, it can be determined that the hand 506 exists.

In order to deal with a case where a skin color other than the color of the hand 506 exists, for example, if the color of the print product 504 is close to the skin, the following method can be applied. That is, when the print state acquiring unit 209 determines “print end”, a frame image (it is possible to use only the first monitoring area) acquired by the management PC 101 from the imaging device 102 is temporarily stored in the RAM as a background image. Then, the medium removing action detecting unit 205 compares the first monitoring area in each frame with the first monitoring area in the background image that is temporarily stored in the RAM. If a difference between the first monitoring areas exceeds a predetermined amount, the medium removing action detecting unit 205 detects a removing action. By the above-described processing, it is possible to more precisely determine a removing action.

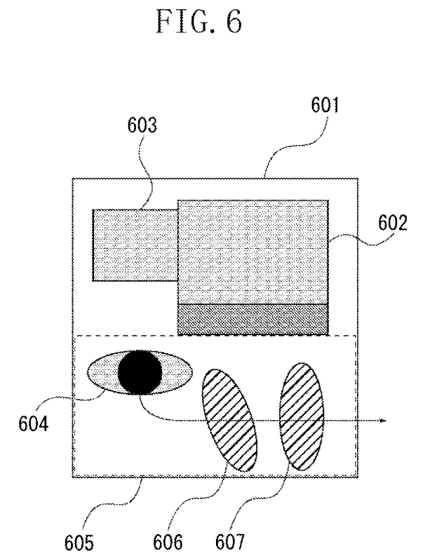

Next, the leaving action determination processing is described in detail. FIG. 6 is a view illustrating an embodiment of an image captured by the imaging device 102 installed above the printing device 100.

In one embodiment, as illustrated in the drawing, a rectangle 601 is an imaging range of the imaging device 102, a rectangle 602 is the printing device 100, a rectangle 603 is the sheet discharge tray of the printing device 100, and an ellipse 604 is a user who has removed a print product.

The user 604 has just finished a removal of the print product and is about to leave the printing device 602.

Within the imaging range 601, an area 605 where the user operates the printing device 602, is defined as a second monitoring area. If the medium removing action detecting unit 205 determines that a removing action is performed, the user who has finished removing the print product exists within the second monitoring area.

In a case where an image is captured by the imaging device 102 from right above the printing device 602, a shape of the user may be roughly an ellipse, as shown for example in FIG. 6. Using this ellipse shape, a position of the user within the second monitoring area may be detected. First, an edge image is extracted from the second monitoring area. To extract the edge, generally, a differential filter is used and an arithmetical operation is performed on each pixel in an area including peripheral pixels. As the filter, a Prewitt filter, a Sobel filter, a Robinson filter, a Kirish filter, or the like can be used. Using these filters, the elliptic shape is extracted from the second monitoring area. To extract the elliptic shape, the following method can be used. First, an elliptic mask image is provided. Then, while a size or tilt of the ellipse and a ratio of a major axis to a minor axis are changed, the mask image is applied to the edge image in the second monitoring area by changing its position. A position where an intensity of the edge image after the application of the mask becomes a maximum value is determined as the ellipse.

Using the edge part of the ellipse obtained as described above as a start point, subsequent frame images are sequentially followed and the ellipses may move as shown by 606 and 607 until the ellipse disappears. Then, it can be determined that the user has left the printing device. As a method to follow the edge part of the ellipse, an edge image in the second monitoring area is calculated for each frame, and from a neighborhood of the edge part of the ellipse detected in an immediately preceding frame, an edge part of an ellipse can be obtained using the above-described method.

In yet another version, differential images can be used. In this method, the medium removing action detecting unit 205 stores a second monitoring area as a background image in the RAM at the time a removing action is detected. Then, a differential image between a following frame image and the background image is calculated. A locus of centers of the differential areas that are moving is calculated, and if the locus disappears from the second monitoring area, it can be determined that the user has left the device.

Then, in one embodiment, as shown for example in steps S406 and S407 in FIG. 4, after it is determined that the user has left the device, the number of users who left is counted, and the processing proceeds to a next step.

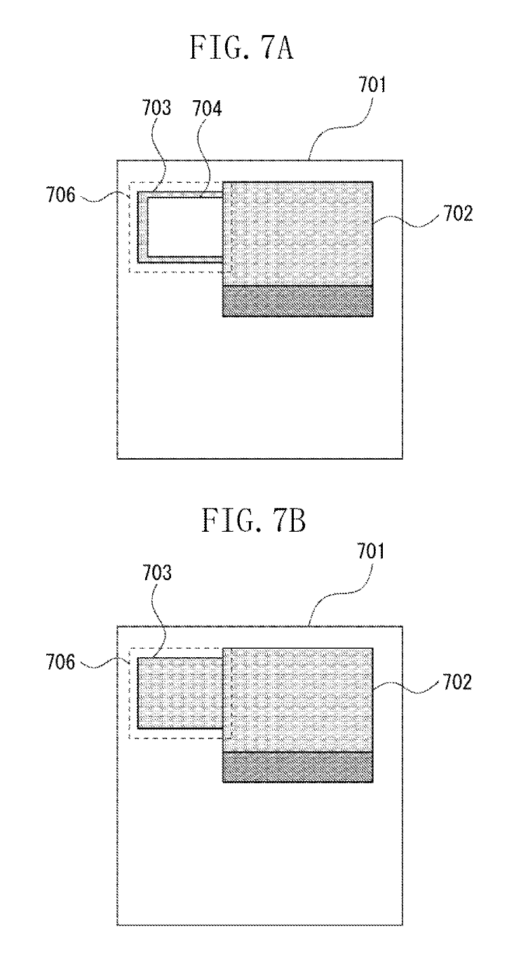

Next, an embodiment of the remaining medium determination processing is described in detail. FIGS. 7A and 7B are views illustrating embodiments of images captured by the imaging device 102 installed above the printing device 100.

In one embodiment, as illustrated in the drawing, a rectangle 701 is an imaging range of the imaging device 102, a rectangle 702 is the printing device 100, and a rectangle 703 is the sheet discharge tray of the printing device 100.

A rectangle 706 is a first monitoring 706 (rectangular area shown by dotted line) in a frame image that is used in a medium removing action determining processing. The rectangle 706 may be set so as to include a sheet discharge tray 703 in the imaging range 701.

A frame image (it is possible to use only the first monitoring area in the frame image) at the time the print state acquiring unit 209 determines “printing end” is temporarily stored in the RAM as a background image. If a background image has already been stored, the background image is continuously used. Then, a difference between the first monitoring area in each frame and the first monitoring area in the background image that is temporarily stored in the RAM is calculated. When a print product 704 is removed, a state shown in FIG. 7A is changed to a state in FIG. 7B. Thus, in the first monitoring area, the part of the print product 704 appears as the difference. If the difference area has a predetermined size, it is determined that “there is no medium”. Until a difference area that has such an enough size appears, it can be determined that “there is a medium”.

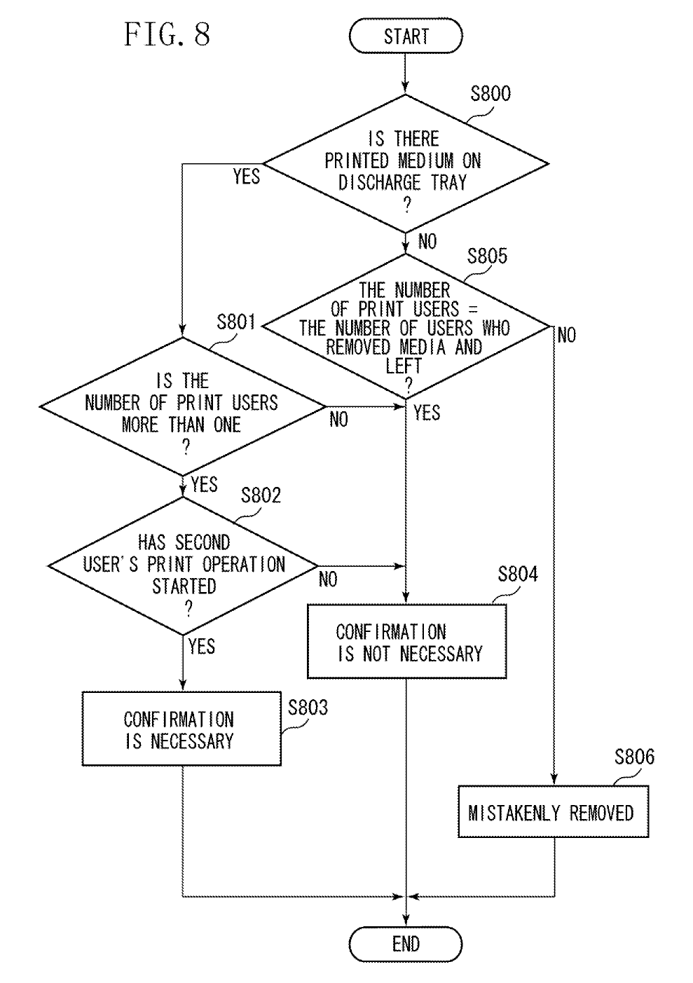

Next, an embodiment of the processing performed in the medium confirmation determining unit 208 is described with reference to a flowchart in FIG. 8.

According to one embodiment of the invention, in step S800, a determination result of the medium detecting medium 207 is checked. Based on a checked result, processing is performed to prompt the user to check the print product or to warn that the print product has been mistakenly removed.

In a case where the print product exists on the sheet discharge tray (YES in step S800), the processing proceeds to step S801. In step S801, it is determined whether the number of users who issued print instructions is more than one. If the number of the users who issued instructions is more than one (YES in step S801), the processing proceeds to step S802. In step S802, it is determined whether printing of a medium of a second user is started. If the printing is started (YES in step S802), the processing proceeds to step S803 in which the medium confirmation determining unit 208 determines that “it is necessary to check the medium”. The print state is checked for following reasons. In a case where three print instructions are issued, for example, two jobs of the user A are issued and subsequently a job of the user B is issued, the number of the print users is two. However, until the third job, that is, the printing by the job of the user B is started, all of the print products on the sheet discharge tray are the print products of the user A. Accordingly, in step S802, if the printing of the second user is not started (NO in step S802), the processing proceeds to step S804. In step S804, the medium confirmation determining unit 208 determined that “it is not necessary to check the print product”. If the number of print users is one in step S801 (NO in step S801), the processing also proceeds to step S804 to determine that “it is not necessary to check the print product”.

Next, the flow of the processing to determine whether a print product has been mistakenly removed by a user is described. In step S800, since it is determined that there is no print product on the sheet discharge tray (NO in step S800), the processing proceeds to step S805. In step S805, it is determined whether the number of print users coincides with the number of users who removed and left. If a user mistakenly removes another user's print product, the number of print users does not coincide with the number of users who removed and left. If the number of print users coincides with the number of users who removed and left (YES in step S805), the processing proceeds to step S804. In step S804, the medium confirmation determining unit 208 determines that “it is not necessary to check the print product” (normal state). If the numbers do not coincide with each other (NO in step S805), the processing proceeds to step S806. In step S806, the medium confirmation determining unit 208 determines that “the print product has been mistakenly removed”.

In a case where a printing speed is high, without determining whether the printing of the second user is started, the medium confirmation determining unit 208 can determine that “it is necessary to check the print product” if the print number of the print user is two or more, and the number of print users is larger than the number of users who removed and left.

Next, the processing performed in the notifying unit 211 for each determination result in the medium confirmation determining unit 208 is described.

When the medium confirmation determining unit 208 determines that “it is not necessary to check the print product”, it is a normal state in which the user does not need to check the print product. In such a case, the notifying unit 211 notifies the printing device 100 that it is not necessary to check the print product. Then, the printing device 100 displays a notice on the display 213 indicating that it is not necessary to check the print product. For example, the notifying unit 211 can transmit a signal to turn on a lamp of the printing device 100 in blue. Alternatively, the notifying unit 211 can transmit a signal to cause the display 213 to display a message that indicates “it is not necessary to check the print product”. Further, in a case where it is not necessary to check the print product, no notification may be transmitted.

If the medium confirmation determining unit 208 determines that “it is necessary to check the print product”, the user may check the print product when the user removes the print product. In such a case, the notifying unit 211 controls the printing device 100 and causes the display unit in the printing device 100 to display a notice that the check may be necessary. For example, the warning unit 211 can transmit a control signal to light the lamp in the printing device 100 in red (giving a warning), to transmit a message “it is necessary to check the print product”, the number of print users, or a signal to produce a display on the display in the printing device 100.

Furthermore, before the user approaches the printing device 100, at the time the user is in front of the client PC 103, the user can also be notified. For example, to all print users, a signal that causes messages “it is necessary to check the print product” to appear on the displays 213 in the client PCs can be transmitted.

When the medium confirmation determining unit 208 determines that “the print product is mistakenly removed”, it is likely that a user near the printing device 100 at the time the print product is mistakenly removed, that is, the user who removed the print product last, probably made the mistake. Accordingly, the notifying unit 211 notifies the user of a warning. For example, the notifying unit 211 can perform control functions to issue a warning sound or a warning message from a speaker in the printing device 100.

Furthermore, the user may remove the print product and leave the printing device without noticing the warning sound. At the time, if another user comes to remove the print product, the print product has already been removed by the other user. In such a case, all print users are notified that the print product has been mistakenly removed and it may be necessary to check the print product. For example, the notifying unit 211 can transmit a message that has a content “Printed medium has been mistakenly removed. Please check the print product.” At the same time, together with the message, if a list including identification information that can specify the print user who could mistakenly have removed the print product is transmitted to the client PC 103, the users can check each other. In such a case, if identification information that can specify device information of the device that issued the print instruction is transmitted, a similar effect can be obtained. Further, the user may have already left the client PC 103. In such a case, the warning in the printing device 100 can be continued. For example, the notifying unit 211 can transmit a control signal to light a lamp (not shown) in red that functions as a warning part in the printing device 100. Further, a predetermined message or a user list can be transmitted and the message or the user list can be displayed on the display 213 that functions as a warning part in the printing device 100.

In the above-described exemplary embodiment, when the number of print users does not coincide with the number of users who removed and left, a warning prompting to check a print product may be issued. However, even when the number of print users coincides with the number of users who removed and left, the notifying unit 211 can issue the warning, which reduces a possibility that users mistakenly remove print product. Further, if the display 213 in the printing device continues to display the number of print users and the number of users who have removed the print product in the current situation, the users can check the display, which also reduces the possibility that the users may mistakenly remove the print product.

In the above-described exemplary embodiment, the printing device is described as an example. However, the present invention can be applied to medium output devices that can output media in response to requests from a plurality of users. For example, a facsimile machine, or a multifunction peripheral in which a plurality of functions are integrated can be used. Further, the medium is not limited to paper, but any medium can be used if the medium can be output to each of a plurality of users. For example, an optical disk or a magnetic disk can be used.

In the above-described exemplary embodiment, both the management PC 101 and the client PC 103 are connected to the same LAN 107. However, the management PC 101 and the printing device 100 can also be integrally formed.

In the above-described exemplary embodiment, the medium detecting unit 207 can analyze a frame image captured by the imaging device 102. However, a sensor as a medium detecting unit can also be mounted in the printing device 100, and used to confirm and determine the medium. For example, a weight of a print product on a sheet discharge tray can be measured. In this case, when the medium detecting unit 207 detects a weight of a predetermined value or more, it can be determined that the “medium exists”.

In the above-described exemplary embodiment, in order to capture an image to be analyzed in the medium removing action detecting unit 205, the medium detecting unit 207, and the leaving action detecting unit 206, the single imaging device 102 is used. However, a plurality of imaging devices can also be used.

For example, an imaging device can capture an image in a first monitoring area and another imaging device can capture an image in a second monitoring area.

In the above-described exemplary embodiment, the management PC 101 processes the program, which is stored in the ROM 1002, corresponding to the flow embodiment shown in FIG. 4. However, the management PC 101 can also process the program in cooperation with the imaging device 102 or the client PC 103.

In the information processing device according to the above-described exemplary embodiment, each configuration can be formed using hardware. In addition, each configuration can be formed using software. Further, each configuration can be formed using a combination of both hardware and software.

Further Furthermore, a system or a CPU (or micro processing unit (MPU)) in device can read the program code corresponding to the flow according to the above-described exemplary embodiment from a storage medium that stores the computer-readable program code and execute the read program code.

In this case, the program code itself, which is read from the storage medium, executes the function of the embodiment mentioned above, and accordingly, the storage medium storing the program code constitutes an aspect of the present invention.

Further, a function enhancing unit connected to a computer can read the program code from the storage medium and a CPU provided in a function enhancing board or the function enhancing unit can execute processing corresponding to the above-described exemplary embodiment.

While the present invention has been described with reference to exemplary embodiments, it is to be understood that the invention is not limited to the exemplary embodiments disclosed herein. Accordingly, the scope of the following claims is to be accorded the broadest interpretation so as to encompass all modifications, equivalent structures, and functions.

This application claims priority from Japanese Patent Application No. 2007-314789 filed in Dec. 5, 2007 which is hereby incorporated by reference herein in its entirety.

What is claimed is:

1. An information processing system comprising:
an outputting device configured to output a medium in response to an output instruction from a user;
an imaging device configured to capture an image in an area that includes the outputting device;
a detecting device configured to detect whether the medium output in response to the output instruction remains in the outputting device; and
a managing device,
wherein the outputting device comprises an outputting user counting unit configured to count the number of users who have instructed to output the medium as the number of outputting users; and
a warning unit configured to issue a warning notified from the managing device, and
wherein the managing device comprises a carrying-away user counting unit configured to count the number of users who removed the output medium and left the printing device as the number of users who removed and left by processing the image captured by the imaging device, and a notifying unit configured to notify the outputting device of a predetermined warning based on existence of the remaining medium detected by the detecting device, the number of users who removed and left, and the number of outputting users.

2. The information processing system according to claim 1, wherein the carrying-away user counting unit comprises a removing action determining unit configured to detect that a predetermined color appears at a position in the captured image and determine a medium removing action of a user; and
a leaving action determining unit configured to compare the captured image with a background image, determine that the user has left a predetermined area in the image, and count the number of users who removed and left,
wherein the leaving action determining unit is configured to operate triggered by a determination of the removing action determining unit that determines the medium removing action of the user.

3. The information processing system according to claim 1, wherein the notifying unit is configured to notify the outputting device of a predetermined warning in a case where the detecting unit detects the remaining medium, the number of outputting users is more than one, and printing by a second output instruction is started.

4. The information processing system according to claim 1, wherein the notifying unit is configured to notify the outputting device of a warning indicating that the medium is mistakenly removed in a case where the detecting unit does not detect the remaining medium, the number of outputting users is more than one, and the number of outputting users is larger than the number of the users who removed and left.

5. The information processing system according to claim 1, further comprising a transmission unit configured to transmit a notification prompting to check the medium, to a client who transmitted the output instruction.

6. The information processing system according to claim 1, wherein the outputting device is a printing device that prints an image on the medium based on image data contained in the output instruction.

7. The information processing system according to claim 1, wherein the outputting user counting unit counts the number of output instructions accepted by the outputting device.

8. The information processing system according to claim 1, wherein the imaging device is a network camera that delivers images sequentially captured to the managing device.

9. The information processing system according to claim 1, wherein the detecting device is apart of the managing device, and configured to detect whether the medium remains by analyzing images captured by the imaging device.

10. The information processing system according to claim 1, wherein the detecting device is configured to detect a weight of the medium output by the output instruction.

11. The information processing system according to claim 1, wherein the warning unit is a display that displays the warning from the notifying unit.

12. The information processing system according to claim 1, wherein the warning unit is configured to issue the warning from the notifying unit by a sound.

13. A method comprising:
detecting whether a medium output in response to an output instruction by a user exists;
counting a number of users who removed the output medium from an outputting device and left the outputting device as the number of carrying-away users;
counting the number of users who issued the medium output instructions as the number of outputting users; and
issuing a predetermined warning based on detected existence of the medium, the number of users who removed and left, and the number of outputting users.

14. The method according to claim 13, further comprising:
detecting an action of removing the medium; and
detecting a leaving action of the user who removed the medium in response to the detection of the removing action, and counting the number of users who removed and left.

15. The method according to claim 13, further comprising:
acquiring a status of an outputting device configured to output the medium; and
issuing the predetermined warning based on the number of users who removed and left, the number of outputting users, and the status of the outputting device.

16. The method according to claim 13, further comprising:
initializing the number of outputting users and the number of users who removed and left when the medium is not detected.

17. The method according to claim 13, further comprising:
issuing the predetermined warning when the medium is not detected, and in a case where the number of outputting users is more than one, and the number of outputting users is larger than the number of users who removed and left.

18. The method according to claim 13, further comprising:
displaying a notification prompting to check the medium.

19. The method according to claim 13, further comprising:
transmitting the notification prompting to check the medium to a device that transmitted the output instruction.

20. The method according to claim 13, further comprising:
notifying of a difference between the number of outputting users and the number of users who removed and left.

21. The method according to claim 13, further comprising:
storing identification information by which a device and/or the user that transmitted the output instruction can be specified; and
notifying of the identification information.

22. A computer readable storage medium comprising instructions for controlling an information processing system having a medium outputting device, the computer readable storage medium comprising:
computer-executable instructions for detecting whether a medium output in response to an output instruction by a user exists;
computer-executable instructions for counting a number of users who removed the output medium and left the printing device as the number of carrying-away users;
computer-executable instructions for counting the number of users who issued the medium output instructions as the number of outputting users; and
computer-executable instructions for issuing a predetermined warning based on detected existence of the medium, the number of users who removed and left, and the number of outputting users.
